(19) United States
(12) Patent Application Publication
(10) Pub. No.: US 2011/0297706 A1
(43) Pub. Date: Dec. 8, 2011

(54) UNIVERSAL FITMENT FOR ATTACHMENT TO SPOUTS

(76) Inventor: Robert A. Zoss, Plymouth, MN (US)

(21) Appl. No.: 12/793,093

(22) Filed: Jun. 3, 2010

(51) Int. Cl. B65D 25/48; B23P 11/00

(52) U.S. Cl. 222/567; 29/428

(57) ABSTRACT

Universal fitments for attachment to spouts having various internal diameters and/or various threadings and methods of using the same. The universal fitments may attach to spouts around their outer diameters and/or within their inner diameters. Some universal fitments include an outer circumferential member having a central aperture extending therethrough and a deformable inner circumferential member adjoined to the inner surface of the outer circumferential member. Other universal fitments include a central longitudinal member and a flexible flange encircling the central longitudinal member. Still other universal fitments include a central longitudinal member having a proximal flange and a distal flange, a circumferential member comprised of a compressible material surrounding the central longitudinal member and abutting the proximal flange, a cap member, and a cylindrical member adjoined to the proximal end of the cap member and having a threaded surface which interacts with the distal flange.

### BACKGROUND

Containers for pourable substances, such as liquids and particulate solids, often include a narrowed neck and a spout for pouring out the liquid. The outside of the spouts are typically threaded in order to interact tightly with a cap having matching threads on the inside of the cap. In this way, the container cap may be removed and replaced as desired, forming a secure, liquid-tight fit.

While it would be desirable to use the threaded spouts of such containers as a way to attach other items to the containers, this is usually difficult or impossible. Although the spouts for containers for a particular use may have the same internal diameter, the spouts will have a variety of types of threading. As such, a fitment that is properly sized may only be used with one specific spout but not others of the same size due to mismatching of the threads. For example, the spouts of individual serving sized milk bottles, such as those available from fast food restaurants and convenience stores, typically have an outer diameter of 38 mm. However, while the spouts may usually be the same size, there are at least 20 different types of threads on such milk bottles. Because of the variety of threading, it has not been possible to design a component which could engage all of the various spouts. Furthermore, in addition to having different threading, some containers for a particular type of product or use may be produced having different spout diameters. These differences in threading and/or spout diameters make it difficult to connect a single fitment to a variety of spouts.

### SUMMARY

Embodiments of the invention include universal fitments of attachments to spouts, such as spouts on containers like bottles. Such fitments may form caps, or may connect the spout to something else such as another spout, another container, or a delivery device such as a sprayer.

In some embodiments the universal fitment is for attachment to a spout having an outer diameter and includes an outer circumferential member having an outer surface forming the outer surface of the fitment, and an inner surface having a central aperture extending therethrough and comprised of a rigid material and a deformable inner circumferential member adjoined to the inner surface of the outer circumferential member. In some such embodiments the outer circumferential member has an inner diameter greater than the outer diameter of the spout, and the inner circumferential member may have an inner diameter less than the outer diameter of the spout. The inner circumferential member may be cylindrical in shape, having an outer surface and an inner surface, and the outer surface may be adjoined to the inner surface of the outer circumferential member. In some embodiments the inner circumferential member is ring shaped, having an inner circumference and an outer circumference, and includes a plurality of tabs extending radially inward, with the outer circumference adjoined to the inner surface of the outer circumferential member. In some embodiments the fitment includes a plurality of inner circumferential members. In some embodiments the fitment may include a central aperture extending through it. In other embodiments the proximal end of the fitment includes a central aperture and the distal end is closed.

In some embodiments the universal fitment for attachment to a spout having an inner diameter and an outer diameter includes a central longitudinal member and a flexible flange. In some such embodiments the central longitudinal member has a proximal end, a distal end, an outer surface and an outer diameter, with the outer diameter being less than the inner diameter of the spout. The flexible flange encircles the central longitudinal member and has an inner circumference and an outer circumference, with the inner circumference adjoined to the outer surface of the central longitudinal member, and with the outer circumference having a diameter which is greater than the inner diameter of the spout. In some such embodiments, the central longitudinal member may have a central aperture extending from the proximal end to the distal end. In some embodiments the fitment may include a plurality of flexible flanges. In some embodiments the fitment also includes an outer circumferential member adjoined to the central longitudinal member at the distal end of the central longitudinal member.

In other embodiments of the universal fitment, the fitment includes a central longitudinal member, a circumferential member, a cap member, and a cylindrical member adjoined to the cap member. The central longitudinal member is comprised of a rigid material and has a proximal end and a distal end with a proximal flange extending radially outward from the proximal end and a distal flange extending radially outward from the distal end. The circumferential member is comprised of a compressible material and surrounds the central longitudinal member, and abuts and is distal to, the proximal flange. The cap member is adjoined to the cylindrical member at the proximal end of the cap. The cylindrical member includes a threaded surface onto which interacts with the distal flange. This threaded interaction causes the distal flange to move toward the cap when the cap is twisted, thereby compressing the circumferential member and causing it to expand outward, toward the sides of a spout, to form a tight fit with the inner surface of the spout.

Embodiments of the invention include the method of attaching a universal fitment to a spout. In some embodiments, the method includes aligning a proximal end of a fitment with a distal end of a spout having an outer diameter, and sliding the fitment onto and/or into the spout to engage the fitment with the inside and/or outside surface of the spout. In some embodiments, the method includes aligning the proximal end of the fitment with a distal end of a spout having an outer diameter. The fitment may include an outer circumferential member having an outer surface forming the outer surface of the fitment, an inner surface, a proximal end having a central aperture, and a distal end and a deformable inner circumferential member adjoined to the inner surface of the outer circumferential member, wherein the inner circumferential member has a central aperture and an inner diameter which is less than the outer diameter of the spout. The method may further include sliding the spout into the aperture in the inner circumferential member thereby deforming the inner circumferential member and forming a secure fit between the spout and the fitment. In some embodiments, the inner circumferential member is cylindrical in shape, having an outer surface and an inner surface, with the outer surface adjoined to the inner surface of the outer circumferential member. In some embodiments, the inner circumferential member is ring shaped, having an inner circumference and an outer circumference and including a plurality of tabs extending radially inward, with the outer circumference adjoined to the inner surface of the outer circumferential member.

### BRIEF DESCRIPTION OF THE DRAWINGS

FIG. 1 is a perspective view of a fitment according to embodiments of the invention.

FIG. 2 is an aerial view of the fitment of FIG. 1.

FIG. 3 is a cross-section of the fitment of FIG. 1.

FIG. 4 is a cross-section of a fitment according to embodiments of the invention.

FIG. 5 is a cross-section of a fitment according to embodiments of the invention.

FIG. 6 is a perspective view of a fitment according to embodiments of the invention.

FIG. 7 is an aerial view of the fitment of FIG. 6.

FIG. 8 is a cross-section of the fitment of FIG. 6.

FIG. 9 is a cross-section of a fitment according to embodiments of the invention.

FIG. 10 is a cross-section of a fitment according to embodiments of the invention.

FIG. 11 is a perspective view of a fitment according to embodiments of the invention.

FIG. 12 is an aerial view of the fitment of FIG. 11.

FIG. 13 is a cross-section of the fitment of FIG. 11.

FIG. 14 is a cross-section of a fitment according to embodiments of the invention.

FIG. 15 is a cross-section of a fitment according to embodiments of the invention.

FIG. 16 is a perspective view of a fitment according to embodiments of the invention.

FIG. 17 is an aerial view of the fitment of FIG. 16.

FIG. 18 is a cross-section of the fitment of FIG. 11.

FIG. 19 is a perspective view of a fitment according to embodiments of the invention.

FIG. 20 is a perspective view of a fitment according to embodiments of the invention.

FIG. 21 is a perspective view of a fitment according to embodiments of the invention.

FIG. 22 is a side view of the fitment of FIG. 21.

FIG. 23 is a cross-section of the fitment of FIG. 22.

FIG. 24 is the fitment of FIG. 23 engaging a spout.

FIG. 25 is a cross-section of a fitment according to embodiments of the invention.

FIG. 26 is a cross-section of a fitment according to embodiments of the invention engaging two spouts.

### DETAILED DESCRIPTION

Embodiments of the invention provide universal fitments for container spouts. In some embodiments, the fitments are able to connect to any spouts having the same internal diameter and/or external diameter. In some embodiments the universal fitment fits around the outside of the spout, while in other embodiments, the universal fitment is inserted into the inside of the spout. In yet other embodiments the universal fitment is inserted both around and inside the spout. In some embodiments the universal fitment is able to connect to spouts having different internal and/or external diameters.

Embodiments of the invention may be used with any spouts, including spouts with or without threading. Typically threaded spouts may be found on containers which store liquids, such as beverages (milk, soda, water, sports drinks, etc.), food ingredients, detergents, cleaning supplies, paint, oil, gasoline, herbicides, pesticides, fertilizers, automotive products, do-it-yourself products such as paints, or any other sort of liquid. However, containers which store non-liquids such as dry solids which may be poured, such as powders, flakes, or other solid particulates such as food and food ingredients, granules, seeds, or even semi-solids such as pastes (toothpaste, frosting) or gels may also be stored in containers having threaded spouts and therefore may also be used in embodiments of the invention. Furthermore, threaded spouts may be located not only on containers but on any item used for transferring a material such as a liquid or solid from a first to a second location, such as a hose, connector device, jar, cup, or mouthpiece to aid in drinking from vessels, such as spill-proof or sippy cup mouthpieces or baby nipples.

Containers having spouts often include a tapered neck which joins the storage portion of the container to the spout. The spout itself is typically tubular, comprising a longitudinally extending round cylinder having a central aperture, an outer diameter and an inner diameter. The proximal end of the spout is adjoined to the neck or body of the container or other sort of unit and the distal end is open for use in dispensing a material. Threads, when present, are thin strips or ridges which extend radially outward from the outside of the spout in a spiraling orientation.

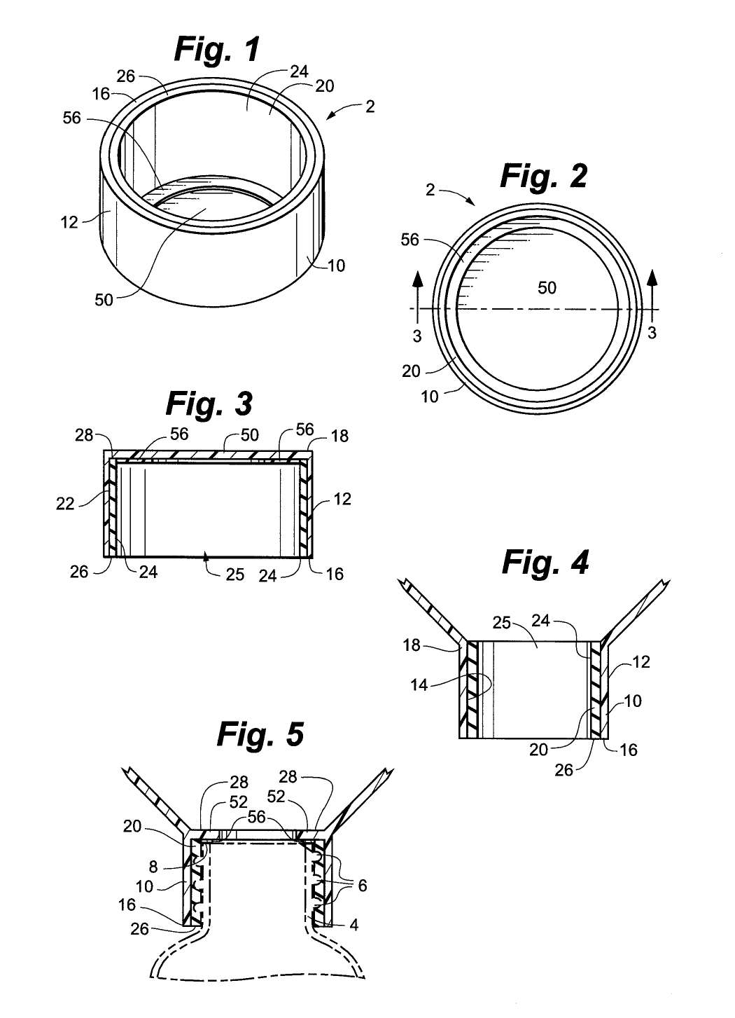

In various first embodiments shown in FIGS. 1-5, the universal fitment 2 fits around the outside of a spout 4. The fitment 2 includes a cylindrical outer circumferential member 10 and a cylindrical inner circumferential member 20. The outer circumferential member 10 includes an outer surface 12 that forms the outer surface of the fitment 2 and an inner surface 14 defining a central aperture 25. The outer circumferential member 10 also has a proximal 16 end, which encircles the spout 4 when in use, and a distal end 18, which may encircle the spout 4 or may extend beyond the distal end 8 of the spout 4 when in use.

The outer circumferential member is typically comprised of a relatively rigid material such as plastic, metal, or polymer such as a bio-polymer to allow the fitment to be gripped around the outer surface 18 of the outer member 10 when applying or removing the fitment 2. The outer surface 18 of the outer member 10 may be smooth or may be textured. For example, it may be ribbed to provide a less slippery gripping surface.

The inner circumferential member 20 also includes an outer surface 22 and an inner surface 24. The inner surface 24 of the inner circumferential member 20 defines a central aperture 25 into which the spout 4 may be inserted. The outer surface 22 of the inner circumferential member 20 abuts and is adjoined to the inner surface 14 of the outer circumferential member 10 along the length of the inner circumferential member 20 from its proximal end 26 to its distal end 28.

The inner circumferential member 20 is comprised of a compressible material, such as a foam or soft rubber, which has the ability to compress and quickly return to its original shape. Examples of appropriate materials for use in the inner circumferential member include foam, rubber, polyolefins such soft polyolefins, polyethylene and polypropylene, rubbers such as synthetic rubber, foams such as polyolefin and polyurethane foams, or layered polymeric film/foam combinations. For example, appropriate materials may have a durometer measurement of between 15 and 60. The inner circumferential member 20 may have an inner diameter which is equal to or less than the outer diameter (excluding the threads 6, if present) of the type of spout 4 with which it is meant to be used. The outer diameter to the inner circumferential member 20 (which is equal to the inner diameter of the outer circumferential member 10) is greater than the outer diameter of the spout 10 (including the threads 6, if present).

The fitments 2 of FIGS. 1-5 may be used with spouts 4 having threading 6 or with spouts 4 without threading 6. In use, a user may grip the fitment 2 around the outside surface 12 of the outer circumferential member 10 and align the proximal end 26 of the inner circumferential member 20 with the distal end 8 of the spout 4. The user may then push the fitment 2 onto the spout 4 such that the inner circumferential member 20 is compressed as it slides around the outside of the spout 4. If the spout 4 includes threads 6, the inner circumferential member 20 is further compressed as it slides over the threads 6. When the fitment 2 is fully advanced into position, the inner circumferential member 20 is compressed at the locations of the threads 6, but expands to a less compressed state (or uncompressed state) between the threads 6. In this way, the fitment 2 forms a liquid-tight secure seal around the spout 4. It may be used with any spout 4 having a particular outer diameter, regardless of the type of threading 6 used on the spouts 4.

Each fitment 4 according to the embodiments shown in FIGS. 1-5 may optionally be sealed at the distal end to form a cap as shown in FIGS. 1-3, or may include a central aperture as shown in FIGS. 4 and 5. In FIGS. 1-3, the proximal end 12 of the outer circumferential member 10 is open, allowing insertion of a spout 4, but the distal end 18 is closed and forms a cap 50. In contrast, in FIGS. 4 and 5, the outer circumferential member is open at both ends, such that the central aperture extends through fitment 2 from the proximal to the distal end to allow the passage of material through the fitment 2, such as into or out of the container which includes the spout. In FIG. 5, the outer circumferential member includes a flange 52 extending radially inward at the distal end 18 of the outer circumferential member 10, distal to the distal end 28 of the inner circumferential member 20.

The embodiments shown in FIGS. 1-3 and 5 may further include a malleable material such as a malleable polymer, rubber, foam or a layered polymeric film and foam combination to form a secondary seal (sealing ring) or gasket 56 which will abut the distal end 8 of the spout 4 when in use. The gasket 56 is located on the proximal surface of the cap 50 or flange 56. In these embodiments, the gasket 56 is annular in shape and is located immediately radially inward from the inner circumferential member 20. However, in embodiments which include a cap, the gasket 56 could alternatively be circular in shape, covering some or all of the proximal surface of the cap 50 at a location radially inward from the inner circumferential member 20. The gasket 56 aligns with and abuts the distal end 8 of the spout 4. When the fitment 2 is compressed onto the spout 4, the gasket 56 is compressed and may be partially deformed by the distal end 8 of the spout 4, thus forming a seal. In some embodiments, a gasket 56 may be used when the material forming the cap 50 or flange 52 of the fitment is harder or more rigid than the material forming the spout, such that the flexible gasket 56 is located between the cap 50 or flange 52 and the distal end 8 of the spout 4.

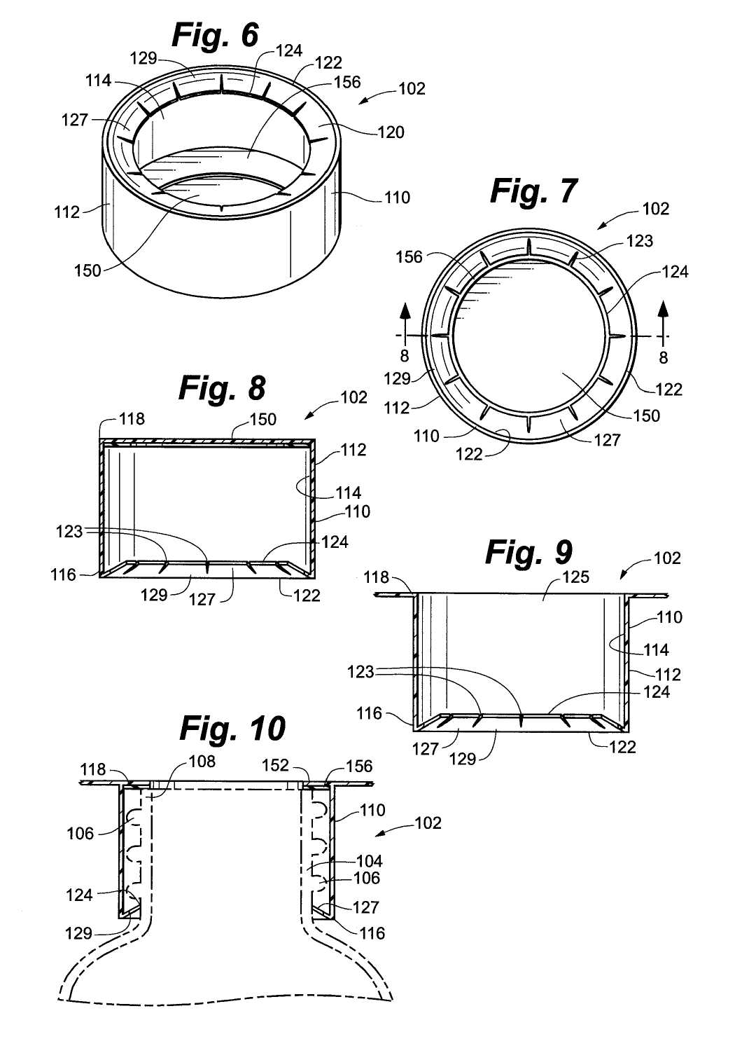

Other embodiments of a universal fitment 102 are shown in FIGS. 6-15. This fitment 102 includes an outer circumferential member 110 and one or more inner circumferential members 120. The other circumferential member 110 is cylindrical, having an outer surface 112 that forms the outer surface of the fitment 102 and an inner surface 114 defining a central aperture. The outer circumferential member 110 also has a proximal end 116, which encircles the spout 104 when in use, and a distal end 118, which may encircle the spout 104 or may extend beyond the distal end 108 of the spout 104 when in use. The outer circumferential member 110 has an inner diameter which is greater than the outer diameter of the spout 104 with which it is designed to be used.

The outer circumferential member 110 is typically comprised of a relatively rigid material, such as plastic, metal, polymer, or biopolymer, to allow the fitment to be gripped around the outer circumference of the outer member when applying or removing the fitment. The outer surface 112 of the outer member 110 may be smooth or may be textured, such as ribbed.

The inner circumferential member 120 has the shape of a thin, flat circular ring extending radially inward from the inner surface 114 of the outer circumferential member 110. The inner circumference 124 has a diameter which is less than the outer diameter of the spout 104 including the threads 106 and which may or may not be smaller than the outer diameter of the spout 104 excluding the threads 106. In some embodiments, the one or more inner circumferential members 120 are adjoined to the inner surface 114 of the outer circumferential member 110. In other embodiments, the one or more inner circumferential members 120 are integrally formed with the outer circumferential member 110 and are comprised of the same material.

The inner circumferential member 120 has an outer circumference 122 adjacent to the inner surface 114 of the outer circumferential member 110 and an inner circumference 124 defining a central aperture 125. The inner circumferential member 120 includes a plurality of slits 123, extending from the inner circumference 124 radially outward from the center of the aperture 125. In some embodiments, the slits 123 extend all the way through the inner circumferential member 120 from the inner to the outer circumference 124, 122, such that the inner circumferential member 120 is composed of multiple separate but directly adjacent tabs 127 which are approximately rectangular in shape and together form a ring. In other embodiments, the slits 123 extend only partially through the inner circumferential member 120, such that the inner circumferential member 120 forms a single structure with the outer circumference 122 undivided. In such embodiments, the inner circumferential member 120 includes an outer ring portion 129 extending radially inward from the outer circumference 122, and a plurality of approximately rectangular tabs 125, extending radially inward from the outer ring portion 129, with the tabs 127 directly adjacent to each other.

The inner circumferential member 120 in embodiments such as that of FIGS. 6-15 is made of a relatively hard and stiff material. However, because the tabs 127 are thin, such as between 0.060 and 0.375 inches in thickness, they are able to flex slightly, bending proximally or distally as the fitment is inserted onto or removed from a spout 104 and bending further as the tabs 127 pass over the threads 106 of the spout 104.

In use, a fitment 120 such as that of FIGS. 6-15 may be gripped by a user around the outer surface 112 of the outer circumferential member 110 and aligned with the distal end 108 of the spout 104. The user may then push the fitment 102 onto the spout 104 such that the tabs 125 of the inner circumferential member 120 flex as they pass over the threads 106 and then partially or fully return to their original position after passing over the thread 106. Because the tabs 125 are stiff, they may make a clicking sound as they pass over the thread 106, so that the user knows whether the fitment 102 has been advanced sufficiently.

Because of the spiraling shape of the threading 106 on the spouts 104, one or more tabs 125 may remain located over a thread 106 when the fitment 102 is fully inserted onto the spout 104. In such circumstances, the tab 125 remains in a more flexed position, but the adjacent tabs 125 will return to a perpendicular position or a less flexed position which is closer to perpendicular. Because this embodiment includes a plurality of tabs 125 on each inner circumferential member 120, only a small portion, such as one tab 125 or maybe two tabs 125, remains flexed by the thread, while the remainder of the tabs 125 extend radially inward to contact the inner surface 114 of the outer circumferential member 110. In this way, leakage of fluid is minimized or prevented. When the fitment 102 is removed, the tabs 125 flex in the opposite direction as they again slide over the threads 106.

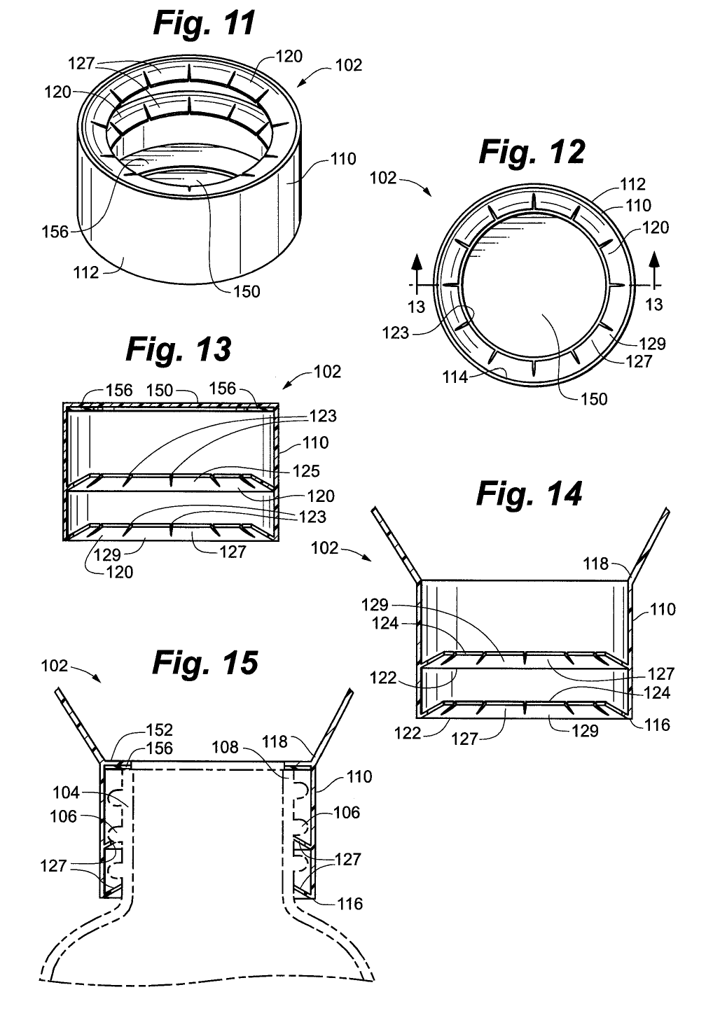

In some embodiments, such as those shown in FIGS. 6-10, the fitment 102 includes only a single inner circumferential member 120. In other embodiments such as those shown in FIGS. 11-15, the fitment 102 includes a plurality of ring shaped inner circumferential members 120 located parallel to each other and in a series, such as 2, 3, or 4 inner circumferential members 120, with each inner circumferential member 120 extending inward from the inner surface 114 of the outer circumferential member 110.

Each fitment 104 according to the embodiments shown in FIGS. 6-15 may optionally be sealed at the distal end to form a cap, or may include a central aperture. In FIGS. 6-8 and 11-13, the proximal end 112 of the outer circumferential member 110 is open, allowing insertion of a spout 104, but the distal end 118 is closed and forms a cap 150. In contrast, in FIGS. 9-10 and 14-15, the outer circumferential member is open at both ends, such that the central aperture extends through fitment 102 from the proximal to the distal end to allow the passage of material through the fitment 102, such as into or out of the container which includes the spout 104. FIGS. 10 and 15 show embodiments in which the distal end 118 of the outer circumferential member 110 extends radially inward to form a flange 152.

The embodiments shown in FIGS. 6-8, 10-13, and 15 may optionally further include a malleable material such as a malleable polymer, rubber, foam, or a layered polymeric film/foam material to form a secondary seal or gasket 156 abutting the distal end 108 of the spout 104 when in use. The gasket 156 is located on the proximal surface of the cap 150 or flange 156. In these embodiments, the gasket 156 is annular in shape and is located immediately radially inward from the inner circumferential member 120. However, in embodiments which include a cap 150, the gasket 156 could alternatively be circular in shape, covering some or all of the proximal surface of the cap 150 at a location radially inward from the inner circumferential member 120.

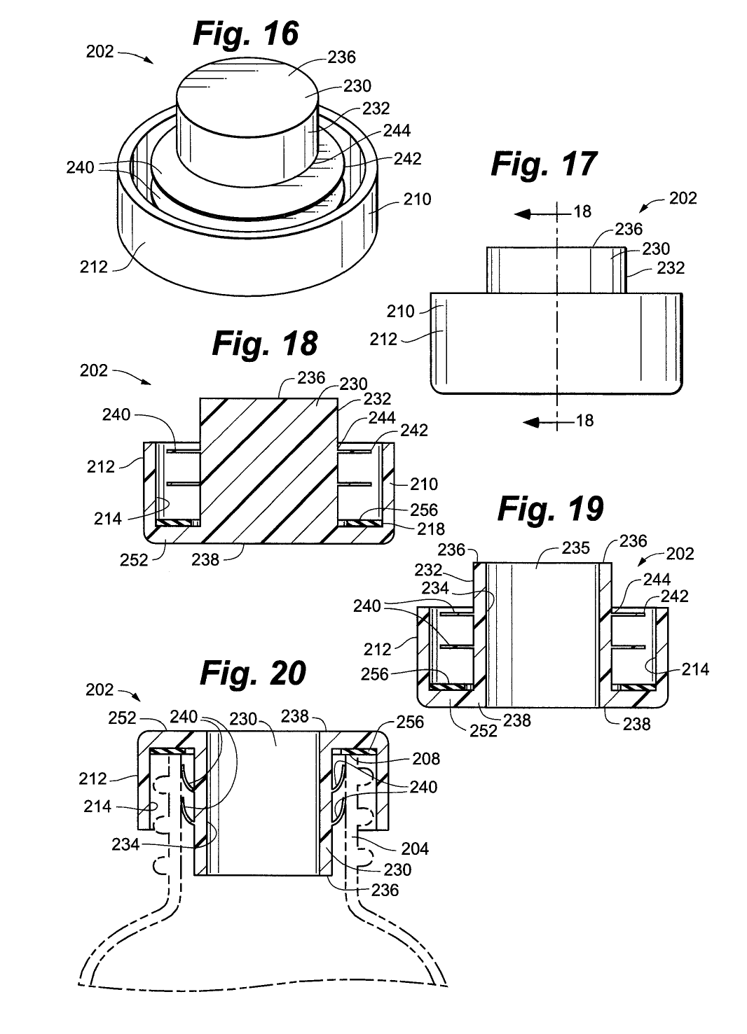

Other embodiments of a universal fitment 202 are shown in FIGS. 16-20, in which the fitment 202 is sized to fit into the inside of a spout 204. As such, the fitment 202 may be used with any spout 204 of an appropriate inner diameter, whether or not the spout has threading 206. The fitment 202 of this embodiment includes a central longitudinal member 230 and one or more flanges 240 encircling the central longitudinal member 230. The central longitudinal member 230 has a circular cross section and an outer surface 232. The diameter of the central longitudinal member at its outer surface 232 is less than the inner diameter of the spouts 204 with which it is meant to be used. The central longitudinal member 230 has a proximal end 236, which is inserted into the spout 204, and a distal end 238, which extends beyond the distal end 208 of the spout 204 after the fitment 202 is inserted. The central longitudinal member 230 may be closed at the proximal end 236 and/or distal end 238 and may be hollow or solid, as shown in FIGS. 16 and 18, for example. Alternatively, the central longitudinal member 230 may include an inner surface 234 surrounding an aperture 235 which passes through the longitudinal member 230 from the proximal to the distal end 236, 238, as shown in FIGS. 19 and 20, for example.

The one or more flanges 240 extend radially outward from the outer surface 232 of the longitudinal member 230, forming a ring around the longitudinal member 230. The flanges 240 may be thin, such as between 0.060 and 0.375 inches and comprised of a stiff material, such that the thinness of the flanges provides them with flexibility. They may be adjoined to the outer surface 232 of the longitudinal member 230, or they may be integrally formed with the longitudinal member 230. The flanges 240 have an inner circumference 244 which adjoins or abuts the longitudinal member 230, and an outer circumference 242, which abuts the inner surface of the spout 204 in use. The diameter of the flanges 240 at the outer circumference 242 is slightly greater than the inner diameter of the spout 204 with which it is intended to be used, allowing it to pass tightly into the spout 204 as described below.

In use, embodiments of the fitment 202 such as that shown in FIGS. 16-20 may be gripped by the user around the outer surface 232 of the central longitudinal member at the distal end 238. Alternatively, the distal end 238 may be flared or may extend radially outward at the distal end to provide an improved grip, or a gripping component having any desired shape may be attached to the distal end of the central longitudinal member 230. In some embodiments, the distal end of the central longitudinal member may be lengthened to extend further distally to provide a grip distal to the distal end 208 of the spout 204 when in use. In the embodiments shown in FIGS. 16-20, the distal end 238 of the longitudinal member 230 is flared radially outward to form a rigid flange 252 which connects to an outer circumferential member 210 at the distal end 218 of the outer circumferential member 210. The outer circumferential member 210 includes an outer surface 212 and an inner surface 214 and surrounds the outside of the spout 204. In use, the proximal end 236 of the central longitudinal member 230 is aligned with the distal end 208 of the spout 204 and the fitment 202 is advanced into the spout 204. As the one or more flanges 240 pass into the spout 204, they flex backward toward the distal end 238 of the fitment 202, forming a tight fit within the spout 204. When the fitment is removed from the spout 204, the flanges 240 flex toward the opposite direction, now bending proximally as the fitment 202 is pulled out.

In some embodiments of the fitment of FIGS. 16-20, the longitudinal member 230 has a uniform circumference or outer diameter throughout its length. In such embodiments, when the embodiments include more than one flange 240, the flanges 240 may each have the same diameter as each other. Alternatively, in some such embodiments, the flanges 240 may increase in size such that the outer diameter of each more distally located flange 240 may increase relative to the more proximally located flanges 240. In other embodiments, the outer diameter of the central longitudinal member 230 may increase as it extends distally, giving the longitudinal member 230 a tapered shape. In such embodiments, the flanges 240 may have a uniform distance from the inner to the outer circumference 244, 242 though having an increasing diameter due to the tapered shape of the central longitudinal member 230. Alternatively, the flanges 240 may increase in size such that the distance between the inner and outer circumference 244, 242 of each flange 240 increases for each more distally located flange. By tapering the size of the longitudinal member 230 and/or of the flanges 240, the fitment 202 may be able to accommodate spouts 104 having a greater variation in size of the internal diameter.

Each fitment 204 according to the embodiments shown in FIGS. 16-20 may optionally be sealed at the proximal end and/or at the distal end to function as a plug, or may include a central aperture. In FIGS. 16-18, the proximal end 236 and distal end 238 of the central longitudinal member 230 are closed such that the fitment 202 acts as a plug. In contrast, in FIGS. 19 and 20, the central longitudinal member 230 includes a central aperture 235 extending from the proximal end 236 to the distal end 238 to allow the passage of material through the fitment 202, such as into or out of a container which includes the spout.

The embodiments shown in FIGS. 16-20 and other embodiments including a flange 252 may further include a malleable material such as a malleable polymer, rubber, foam or a layered polymeric film/foam material to form a secondary seal or gasket 256 abutting the distal end 208 of the spout 204 when in use. The gasket 256 may be located on the proximal surface of the flange 252, for example, and is annular in shape.

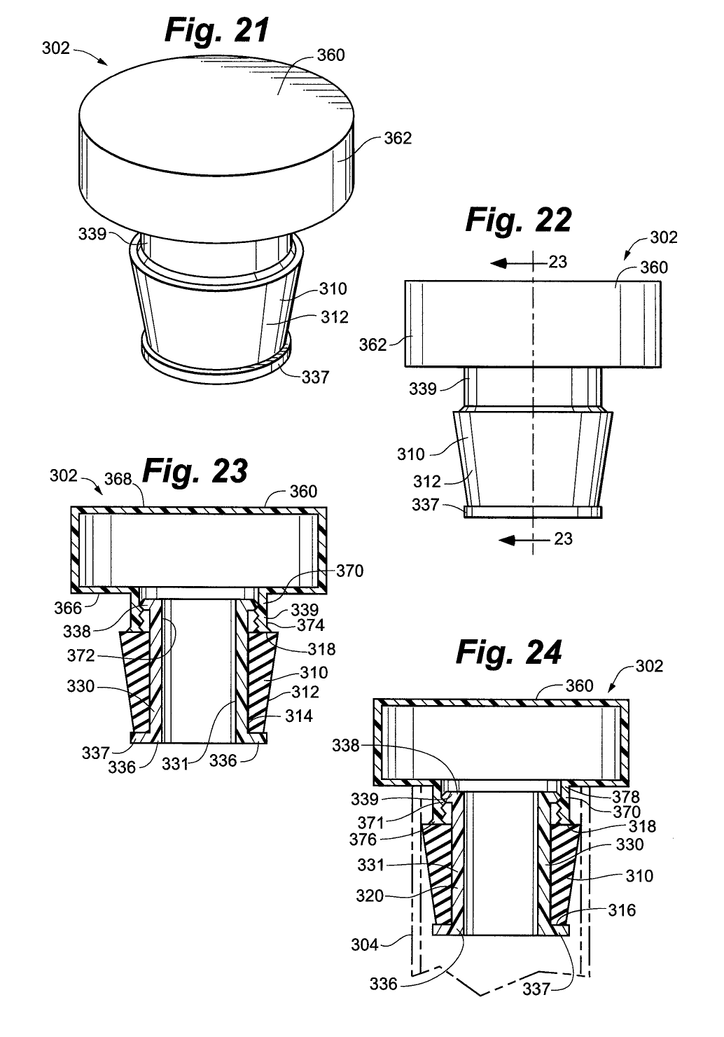

Other embodiments in which the fitments are inserted into a spout are shown in FIGS. 21-24. In these embodiments, the fitment 302 includes a circumferential member 310, a central longitudinal member 330, and a cap portion 360. The circumferential portion is cylindrical in shape and includes an outer surface 312 and an inner surface 314. The circumferential portion 310 surrounds the central longitudinal member 330 on its outer surface 332. In the embodiment shown, the central longitudinal member 330 includes an central aperture 335 extending therethrough and an inner surface 334 surrounding the aperture 335. In alternative embodiments the central longitudinal member 330 may have no aperture and/or may be capped at the proximal end 336 and/or the distal end 338.

The central longitudinal member 330 is comprised of a rigid material such as plastic or metal. The central longitudinal member 330 includes a longitudinal portion 331 extending from a proximal end 336 to a distal end 338, a proximal flange 337 perpendicular to the longitudinal portion 331 and encircling and extending radially outward from the proximal end 336, and a distal flange 339, perpendicular to the longitudinal portion 331 and extending radially outward from the distal end 338. The outer diameter of the proximal flange 337 is less than the inner diameter of the spout 304 with which it is to be used.

The circumferential portion 320 which surrounds the central longitudinal member 330 is comprised of a soft, flexible, elastomeric material such as rubber or a flexible polymer. The circumferential member 310 includes a proximal end 316 and a distal end 318. The proximal end 316 of the outer circumferential portion is distal to and abuts the proximal flange 337 of the central longitudinal member 330. In some embodiments, the outer circumferential member is tapered, such as the embodiments shown in FIGS. 21-24. In such embodiments, the outer diameter of the circumferential member is smaller at the proximal end 326 than at the distal end 328, with the outer diameter at the proximal end 326 being less than the inner diameter of the spout 304, allowing at least the proximal end 326 to be inserted into the spout 204. In some embodiments, such as the embodiments shown, the outer diameter of the distal end 318 of the outer circumferential member may be equal to or slightly less than the inner diameter of the spout 304, in which case it can be fully inserted into the spout. In other embodiments, the outer diameter of the circumferential member 320 at the distal end 328 may be greater than the inner diameter of the spout 304, in which case the circumferential member 320 can only be partially inserted into the spout 304. Alternatively, the circumferential member 320 may not be tapered and may have a uniform outer diameter which is equal to or slightly less than the inner diameter of the spout 304.

The cap portion 360 is generally ring shaped or disk shaped and has a circular outer surface 362, a proximal end 366 and a distal end 368. The proximal and distal ends 366, 368 may be open with an aperture extending through the cap 360 in which case the cap also has an inner surface, or one or both ends 336, 338 may be closed. A ring shaped structure 370 extending longitudinally from the proximal end 336 of the cap. The ring 370 includes a proximal end 376, a distal end 378 adjoined to the proximal end 366 of cap 360, an outer surface 372 and an inner surface 374. The inner surface 372 includes threading which interacts with the distal flange 339. As a result of this threaded connection, as the cap portion 360 is twisted, the threading on the ring 370 spins relative to the distal flange 339 such that the distal flange 339 moves either toward the cap 360 or away from the cap 360, depending upon the direction of rotation of the cap portion 360 and the orientation of the spiraled threading. As the distal flange 339 is moved toward the cap portion 360, the circumferential member 310 becomes compressed between the proximal flange 336 of the central longitudinal member 330 and the ring 370. Because the outer circumferential member 310 is comprised of a soft material, it expands radially outward to press against the inside of the spout 304 and form a tight seal. To remove the fitment 302, the cap 360 can be rotated in the opposite direction, moving the distal flange 339 (and the proximal flange 337) away from the cap portion 360, allowing the outer circumferential member 310 to return to its original size and retract inwardly away from the inside of the spout 304.

Other embodiments of the invention include an inflatable donut seal which could be attached to either the inner diameter or the outer diameter. The inflatable donut seal may be a circular seal that could be expanded through air injection, such as piston action air injection. Air injection may be done manually or may be activated by a lever or a circular screw mechanism. Such embodiments may also optionally include a gasket comprised of a malleable material fitting over the top of the spout.

Other embodiments may include a compressive polymer seal which may be attached to either the inner or outer diameter. This seal would comprise a circular malleable polymer seal that may be compressed by a concentrically slotted band (such as a worm screw mechanism) activated by a lever or a circular screw mechanism. These embodiments may also optimally include a gasket as described above.

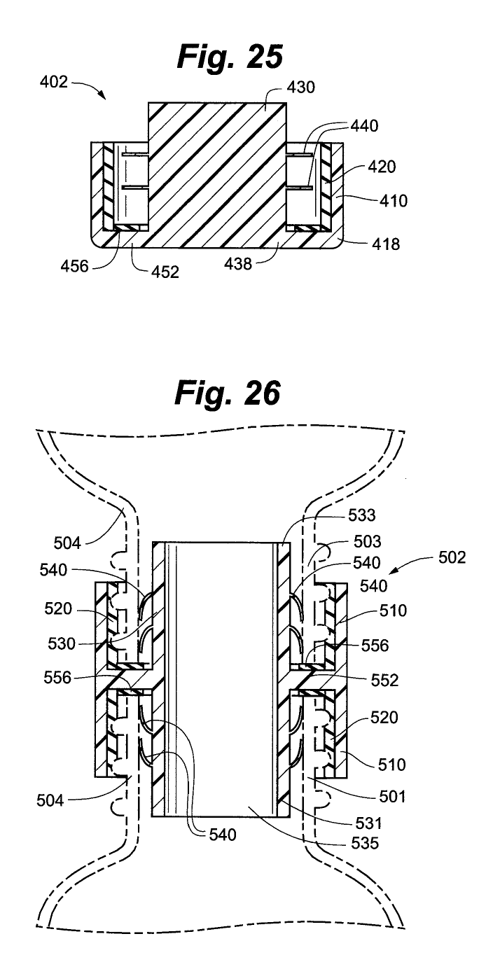

In some embodiments, the fitment may include a combination of any of the fitments described herein. For example, any one of the embodiments in which the fitment fits around the outside of a spout may be used in combination with any one of the fitments which may be inserted inside of a spout. The fitments may be adjoined at the distal ends, forming a single fitment that fits both around and inside of the spout. An example of such an embodiment is shown in FIG. 25. In this embodiment, the fitment 402 includes an outer circumferential portion 410 and an inner circumferential portion 420 as described with regard to the embodiments shown in FIGS. 1-5, in combination with and surrounding a central longitudinal member 430 and having one or more flanges 340 as described with regard to the embodiments shown in FIGS. 16-20. The distal end 418 of the outer circumferential portion 410 includes a flange 454 which extends radially inward to connect to the distal end of the central longitudinal member 430. The proximal surface of the flange may include a gasket 456 as described above which will abut the distal end of the spout when in use.

In other embodiments, the fitment may be used to attach one spout to another spout. In such embodiments, the fitment may include a combination of any two of the above described embodiments, connected in series at their distal ends, wherein the two embodiments may be the same as each other or may be different. An example of such a fitment is shown in FIG. 26, in which the fitment is shown connecting two threaded spouts together to allow the passage of material between two reservoirs. The embodiment shown in FIG. 26 can be seen to be similar to a combination of two fitments like that of FIG. 25, combined at their distal ends and including a central aperture 535. In this embodiment, the fitment 502 includes a central longitudinal member 530 having a central aperture and extending from a first end 531 to a second end 533 for insertion into a first and second spout 501, 503. Two or more flexible flanges 540 encircle and extend radially outward from the central longitudinal body 530. In the embodiment shown, a rigid flange 552 extends radially outward from the central longitudinal body 530, at or near its midpoint, to connect the central longitudinal body to an outer circumferential member 510 and a pair of inner circumferential members 510. The rigid flange 552 has a gasket 556 on its first and second surfaces, to abut the distal ends of the spouts 504.

Embodiments of the fitment which allow the passage of material can be used in a variety of ways. For example, they may be used to attach a liquid container having a spout to another container having a fitment. In some embodiments, a cereal container may be designed to include a universal fitment which may be used with the spout of a milk container, allowing the cereal container to be connected to any milk container.

In other embodiments, the fitment may be used to provide a functional attachment to the container having a spout. For example, the distal end of the fitment may be adjoined to or formed into a funnel shape. In this way, the fitment allows the funnel to securely attach to the spout so that material can be poured into the container having the spout. In another example, the distal end of the fitment may be shaped into any style of a top of a spill-proof or sippy cup.

In some embodiments, the distal end of the fitment is solid and functions as a cap to seal in the contents of the container having the spout, such as particulates, powder or liquids. Alternatively, the distal end of the fitment may form a cap but may include an aperture. The aperture may provide pressure relief. In some embodiments, the aperture may have a diameter which is sized to accommodate a tube such as a siphon tube. For example, the aperture may be sized approximately equal to the external diameter of a tube with which it may be used, such as a siphon tube. In such embodiments, the fitment may be used with a pump, such as a pump mounted on the fitment, such as above or on top of the fitment, and the siphon tube may pass from the pump and through the aperture in the cap of the fitment and extend into the space beneath the spout, such as into a container, for example. In this way, a pump may be connected to a spout using a universal fitment according to embodiments of the invention, with the siphon tube passing through the fitment such that the contents of the container. In this way, the container may be lower than the pump, and the contents can be removed by the action of the pump and delivered through the siphon tube to the outside of the container. For example, a system including a universal fitment having an aperture for a tube, such as a siphon tube, and a pump may be used to connect to a spout portion of a container to pump the contents of the container into the exterior environment. The contents can be delivered as a spray or an aerosol, for example.

In some embodiments, the universal fitment may be used with any type of dispensers. For example, they may be used with, or be a component of, motorized sprayers, such as for herbicides, pesticides, fertilizers, automotive product, cleaning supplies, and do-it-yourself products such as coatings. In other examples, the universal fitments may be used with, or be a component of, dosing dispensers for liquids, powders and particulates such as for cleaning supplies and food ingredients. In still other examples, they may be used with or be a component of grinder attachments, such as for spices, and with motorized pumping/squirting product delivery mechanisms, such as cleaning products. In still other examples, they may be used with or be a part of motorized particulate sprinkling and/or dosing dispensers, such as for lawn care products, garden care products and shrub care products.

The universal fitments may be used with detergents or cleaners to allow them to be packaged in a more concentrated form. By providing them in a more concentrated form, the cost is lowered for the product, the packaging, and the distribution. Packaging material is reduced, the shelf footprint is more efficient, consumer transportation is easier, and consumer inventorying is increased. In addition, the universal fitment can be used with reusable dispensers for refill packaging. The universal fitment may be used to provide dispensing, dosing, product mixing, product replenishment reminders and dosing analysis.

In some embodiments, it may be necessary to use the fitments with spouts having a variety of diameters. In such cases, the fitments may be provided in a variety of sizes, such as in a kit, to accommodate spouts of different sizes.

In the foregoing detailed description, the invention has been described with reference to specific embodiments. However, it may be appreciated that various modifications and changes can be made without departing from the scope of the invention as set forth in the appended claims. Thus, some of the features of preferred embodiments described herein are not necessarily included in preferred embodiments of the invention which are intended for alternative uses.

1. A universal fitment for attachment to a spout having an outer diameter, the fitment comprising:
an outer circumferential member having an outer surface forming the outer surface of the fitment and an inner surface having a central aperture extending therethrough and comprised of a rigid material;
a deformable inner circumferential member adjoined to the inner surface of the outer circumferential member;
wherein the outer circumferential member has an inner diameter greater than the outer diameter of the spout, and wherein the inner circumferential member has an inner diameter less than the outer diameter of the spout.

2. The fitment of 1 wherein the inner circumferential member is cylindrical in shape, having an outer surface and an inner surface, wherein the outer surface is adjoined to the inner surface of the outer circumferential member

3. The fitment of 2 wherein the fitment includes a central aperture extending therethrough.

4. The fitment of 1 wherein the inner circumferential member is ring shaped, having an inner circumference and an outer circumference and comprising a plurality of tabs extending radially inward, wherein the outer circumference is adjoined to the inner surface of the outer circumferential member.

5. The fitment of 4 wherein the proximal end of the fitment includes a central aperture and the distal end is closed.

6. The fitment of 4 comprising a plurality of inner circumferential members.

7. A universal fitment for attachment to a spout having an inner diameter and an outer diameter, the fitment comprising:
a central longitudinal member having a proximal end, a distal, an outer surface and an outer diameter, wherein the outer diameter is less than the inner diameter of the spout;
a flexible flange encircling the central longitudinal member and having an inner circumference and an outer circumference, wherein the inner circumference is adjoined to the outer surface of the central longitudinal member, and wherein the outer circumference has a diameter which is greater than the inner diameter of the spout.

8. The fitment of 7 wherein the central longitudinal member has a central aperture extending from the proximal end to the distal end.

9. The fitment of 7 further comprising an outer circumferential member adjoined to the central longitudinal member at the distal end of the central longitudinal member.

10. The fitment of 7 comprising a plurality of flexible flanges.

11. A universal fitment for attachment to a spout, the fitment comprising:
a central longitudinal member comprised of a rigid material having a proximal end and a distal end wherein a proximal flange extends radially outward from the proximal end and a distal flange extends radially outward at the distal end;
a circumferential member comprised of a compressible material surrounding the central longitudinal member and abutting the proximal flange;
a cap member having a proximal end; and
a cylindrical member adjoined to the proximal end of the cap member and having a threaded surface onto which interacts with the distal flange.

12. A method of attaching a fitment to a spout comprising:
aligning a proximal end of a fitment with a distal end of a spout having an outer diameter, the fitment comprising:
an outer circumferential member having an outer surface forming the outer surface of the fitment, an inner surface, a proximal end having a central aperture, and a distal end;
a deformable inner circumferential member adjoined to the inner surface of the outer circumferential member, wherein the inner circumferential member has a central aperture and an inner diameter which is less than the outer diameter of the spout;
sliding the spout into the aperture in the inner circumferential member thereby deforming the inner circumferential member and forming a secure fit between the spout and the fitment.

13. The method of 12 wherein the inner circumferential member is cylindrical in shape, having an outer surface and an inner surface, wherein the outer surface is adjoined to the inner surface of the outer circumferential member.

14. The method of 12 wherein the inner circumferential member is ring shaped, having an inner circumference and an outer circumference and comprising a plurality of tabs extending radially inward, wherein the outer circumference is adjoined to the inner surface of the outer circumferential member.
